(19) United States
(12) Patent Application Publication
(10) Pub. No.: US 2007/0279595 A1
(43) Pub. Date: Dec. 6, 2007

(54) ILLUMINATION SYSTEM AND PROJECTION SYSTEM USING SAME

(75) Inventor: Simon Magarill, Cincinnati, OH (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/421,797

(22) Filed: Jun. 2, 2006

(51) Int. Cl. G03B 21/00

(52) U.S. Cl. 353/33

(57) ABSTRACT

An optical display system includes a light source, for generating light in first, second and third color bands, and a projection core. The projection core includes a crossed color combiner and first, second and third display panels disposed to direct first, second and third image light into the color combiner. The display panels are arranged for forming images in the light in the first, second and third color bands respectively. An optical relay system relays illumination to the first, second and third imager panels. A first dichroic separator is disposed in the light beam between the light source and the projection core, and separates light in the first color band from light in the second and third color bands. The lengths of optical paths from the first dichroic separator to each of the three display panels are all substantially equal.

### FIELD OF THE INVENTION

The present invention relates to illumination systems that may be used in projection systems and projection systems using the illumination systems. More specifically, the invention relates to illumination systems that use a reduced number of optical elements for transferring the illumination light from the light source to the imager panels.

### BACKGROUND

Illumination systems have a variety of applications, including projection displays, backlights for liquid crystal displays (LCDs) and others. Projection systems, for example as found in projection televisions and monitors, usually include a source of light, illumination optics, an image-forming device, projection optics and a projection screen. The illumination optics collect the light generated by the light source and direct the collected light to one or more image-forming devices. The image-forming device(s), controlled by an electronically conditioned and processed digital video signal, produces an image light beam corresponding to the video signal. Projection optics magnify the image light beam and project it to the projection screen.

There is a need that the illumination optical system, i.e. the optics used for transferring the illumination light to the image-forming devices, is simple to assemble and align. Furthermore, it is preferable that the illumination optical system be simple and inexpensive. At the same time, it is preferred that the footprint of the projection system be reduced so that the system can fit into smaller volumes.

### SUMMARY OF THE INVENTION

One embodiment of the present invention is directed to an optical display system that includes a light source unit capable of generating a light beam containing light in at least first, second and third color bands and a projection core. The projection core includes a crossed color combiner having first, second and third inputs and an output, and also includes first, second and third display panels disposed to direct first, second and third image light to the first, second and third inputs respectively. The first, second and third display panels are arranged for forming images in the light in the first, second and third color bands respectively. An optical relay system relays light of the light beam to the first, second and third imager panels. A first dichroic separator is disposed in the light beam between the light source and the projection core. The first dichroic separator separates light in the first color band from light in the second and third color bands. The light beam is incident on the first dichroic separator with an incident angle of incidence less than 40°. The light beam is non-telecentric where it is incident on the first dichroic separator.

Another embodiment of the invention is directed to an optical display system that includes a light source unit capable of generating a light beam containing light in at least first, second and third color bands and a projection core. The projection core includes a crossed color combiner having first, second and third inputs and an output, and first, second and third display panels disposed to direct first, second and third image light to the first, second and third inputs respectively. The first, second and third display panels arranged for forming images in the light in the first, second and third color bands respectively. An optical relay system relays light of the light beam to the first, second and third imager panels. A first dichroic separator is disposed in the light beam between the light source and the projection core. The first dichroic separator separates light in the first color band from light in the second and third color bands. A first optical path length from the first dichroic separator to the first display panel for light in the first color band is substantially equal to a second optical path length from the first dichroic separator to the second display panel for light of the second color band and is substantially equal to a third optical path length from the first dichroic separator to the third display panel for light of the third color band.

The above summary of the present disclosure is not intended to describe each illustrated embodiment or every implementation of the present disclosure invention. The figures and the following detailed description more particularly exemplify these embodiments.

### BRIEF DESCRIPTION OF THE DRAWINGS

The disclosure may be more completely understood in consideration of the following detailed description of various exemplary embodiments in connection with the accompanying drawings, in which:

FIG. 1 schematically illustrates an embodiment of a projection system according to principles of the present invention;

FIG. 2 schematically illustrates an embodiment of a projection system showing selected distances between certain system components;

FIG. 3 schematically illustrated another embodiment of a projection system according to principles of the present invention; and

FIG. 4 schematically illustrates a polarization converter unit used with the projection system of FIG. 2.

Like numerals in different figures refer to similar elements. While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is applicable to illumination systems for projection displays, and is believed to be particularly useful for rear projection displays such as televisions and monitors, and also for front projection systems.

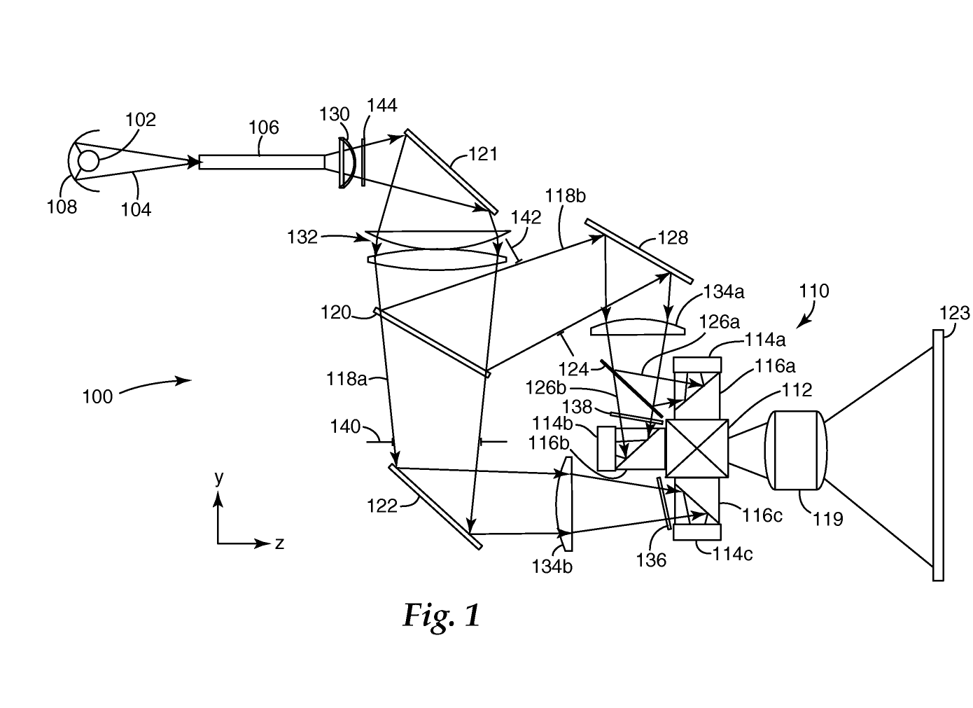

FIG. 1 schematically illustrates a projection system 100. A light source 102 generates illumination light 104 that is directed into a tunnel integrator 106. The light source 102 may be any suitable type of light source, for example a high pressure mercury lamp, one or more light emitting diodes (LEDs), or some other type of light source. The light source 102 may also include a combination of different types of light sources, for example a combination of a high pressure mercury lamp and one or more LEDs. An optional reflector 108 may be used to increase the amount of illumination light 104 incident at the entrance end of the integrator 106. Other elements, for example one or more lenses positioned between the light source 102 and the integrator 106, may also be used to increase the intensity of the light 104 entering the integrator 106. The integrator 106 may be a tunnel integrator, but this is not a requirement. A tunnel integrator may be trapezoidal, in other words, the integrator 106 it is tapered to expand towards the output. Thus, an integrator 106 that has a square input may have a rectangular output.

Upon exiting the integrator 106, the light 104 is directed towards the projection core 110, which includes an x-cube color combiner 112, imaging devices 114a-114c and respective polarizing beamsplitters (PBSs) 116a-116c. One example of a suitable projection core is the Vikuiti™ Optical Core available from 3M Company, St. Paul, Minn. The projection core may include various polarization control elements, such as quarter-wave retarders and the like, not shown in FIG. 1. In some embodiments, the light 104 may be directed towards the projection core 110 by an optional first folding mirror 121. In other embodiments, the light 104 may propagate from the exit of the integrator 106 in the negative Y-direction, without the need for the first folding mirror 121.

Each imaging device 114a-114c and its associated PBS 116a-116c is used to form an image in a respective color band, which is combined in the color combiner 112 with the colored images produced by the other imaging devices 114a-114c to form a full color image. The full color image is projected by a projection lens unit 119 to a projection screen 123.

The light 104 is split into different color components, associated with different color channels, for separately illuminating the different imaging devices 114a. For example, the light 104 is split into first and second separated beams 118a, 118b at a first dichroic separator 120. The first separated beam 118a is directed via a second folding mirror 122 to imaging device 114c, while the second separated beam 118b is split by a second dichroic separator 124 into third and fourth separated beams 126a and 126b which are directed respectively to imaging devices 114a and 114b. A third folding mirror 128 may be used to direct the second separated light beam 118b towards the projection core 110.

In other embodiments, the light beam 106 may be incident on the first dichroic separator 120 from a different direction, with the first separated beam 118a being reflected by the first dichroic separator 120 and the second separated beam 118b being transmitted through the first dichroic separator 120.

An image of the output of the integrator 106 is relayed to the imaging devices 114a-114c using an image relay system that includes a number of lenses. In this exemplary embodiment, the image relay system includes a negative first lens unit 130 positioned close to the output of the integrator 106, a positive second lens unit 132, and two third lens units (TLUs) 134a and 134b. The first lens unit 130 and second lens unit 132 are common to all colors, since they are positioned before the first dichroic separator 120. One of the two TLUs 134b is used by one color of light, and the other TLU 134a is used by light of two colors. The two TLUs 134a, 134b are spaced apart from the second lens unit 132 by the same optical path length, and the two TLUs 134a, 134b may have the same focal length. In some conventional types of illumination systems, different color channels require lenses of different optical lengths, which complicates the assembly. In contrast to these conventional systems, when the TLUs 134a, 134b have the same focal length, the number of different types of lenses required to assemble the illumination system is reduced. Also, the optical path length for illumination light may be substantially the same from the first dichroic separator 120 to each of the imager devices 114a-114c. This ensures that all image devices 114a-114c are illuminated using substantially identical illumination beams, so that the color and intensity properties of the resulting full color image are uniform.

The different lens units 130, 132, 134a, 134b may be formed using one or more lens elements. In the exemplary embodiment illustrated in FIG. 1, the first lens unit 130 and the third lens units 134a, 134b, each include only a single lens element, while the second lens unit 132 includes two lens elements 132a, 132b. It will be appreciated that the number of lens elements used in each lens unit may be different depending on the type of optical system employed. For example, the second lens unit may be formed of a single lens, such as an aspherical lens, instead of the doublet illustrated in FIG. 1.

Typically, an illumination system that illuminates three imager devices with light of three different colors requires a telecentric light arrangement at the imager devices to provide uniform contrast across the field. This means that identical cones of light illuminate different zones of the imager devices. Although the illumination light 118a, 126a, 126b is incident on the imaging devices as telecentric light, the light is not telecentric at all points within the image relay system. A telecentric system is one where the aperture stop is located at the front focus, resulting in the chief rays being parallel to the optical axis in image space, i.e. the exit pupil is at the infinity. Consequently, in a telecentric light beam, the angular distribution of light at one point of an imager device is the same as the angular distribution of light at another location of the imager device. Where a light beam is non-telecentric, the angular distributions of the light associated with the two points of the imager are different. Thus, in the illumination system illustrated in FIG. 1, light in the space of the imager devices 114a-114c is telecentric, whereas light in the space of the first dichroic separator 120 is non-telecentric.

Since the light 104 in the space of the first dichroic separator 120 is non-telecentric, various portions of the light beam 104 coming onto different points of the imager devices 114a-114c are incident at the first dichroic separator 120 with different angular distributions. The dichroic separator 120 is typically formed of a multilayer dielectric coating whose optical properties are dependent on the angle of incidence. Consequently, the spectrum of light passed by the first dichroic separator 120 is not uniform across the imagers 114a-114c. This phenomenon is often referred to as color shift. A first trim filter 136 may be disposed in the first separated beam 118a to uniformize the spectrum of light incident at the third imager device 114c. A second trim filter 138 may also be used to trim the spectrum of light whose wavelength band is adjacent the wavelength band of the light in the first separated beam 118a. For example, where the light in the fourth separated beam 126b is green and the light in the first separated beam 118a is red, then a second trim filter 138 may be disposed in the fourth separated beam 126b. In some exemplary embodiments, the trim filters 136 and 138 are tilted with respect to the incident light beams. This eliminates the reflection of some light back to the imager devices, 114a-114c, which can otherwise result in ghosting effects. In some exemplary embodiments the trim filters 136 and 138 may be tilted at an angle of about 12° relative to an axis of the incident light.

The first dichroic separator 120 is oriented so that the axis of light 104 incident on the first dichroic separator 120 is less than 45°. Instead, the light is incident on the first dichroic separator at an angle of less than 40°, and may be less than 35° or even 30°. This permits the illumination path lengths to the imager devices 114a-114c to be the same when using an x-cube color combiner for combining the image light beams. The actual angle of incidence on the first dichroic separator 120 is a design choice that is affected, at least in part, by the size of the system components, particularly the diameter of the third lens unit 134a and the width of the light beam 118a. In some embodiments the angle of incidence of the light 118b on the third folding mirror 128 is substantially the same as the angle of incidence of the light 104 on the first dichroic separator 120, and so the light reflected by the third folding mirror 128 is substantially parallel to the light 104 incident on the first dichroic separator.

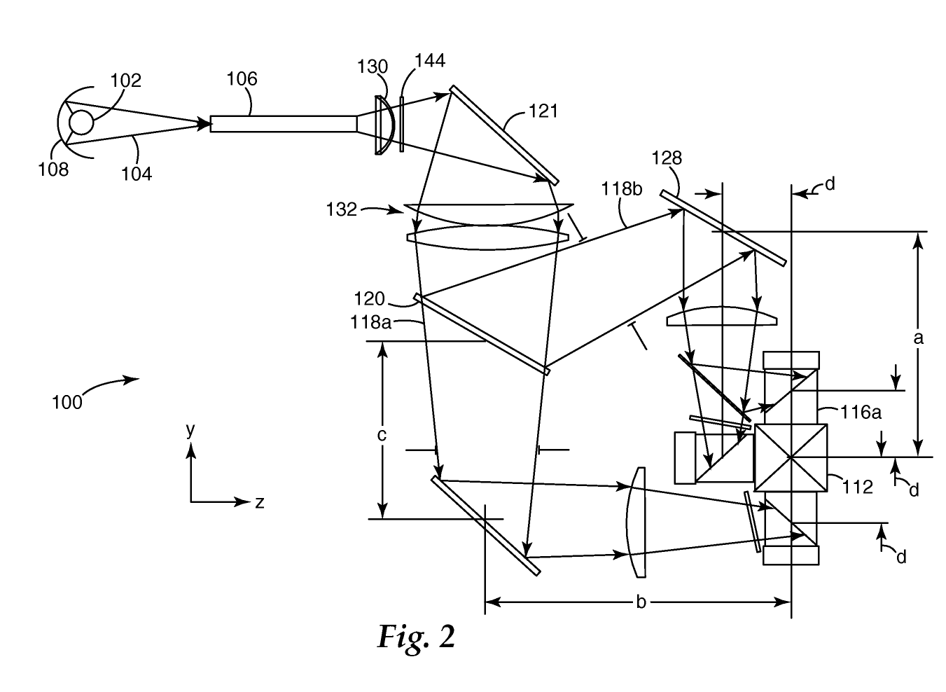

The angle of incidence on the first dichroic separator 120 being less than 45° and the ability to maintain the same optical path lengths for all three color channels can be understood further with reference to FIG. 2. The figure shows substantially the same system 100 as FIG. 1, but with distances between certain components labeled. The distance labeled “a” is the distance in the y-direction from the center of the x-cube combiner unit 112 to the point where the axial ray of light beam 118b is incident on the third folding mirror 128. The distance “b” is the distance along the z-axis between the center of the x-cube combiner unit 112 and the point where the axial ray of light beam 118a is incident on the second folding mirror 122. The distance “c” is the distance in the y-direction between the point where the axial ray of light beam 118a is incident on the second folding mirror 122 and the point where the axial ray of light beam 104 is incident on the first dichroic separator 120. The distance “d” represents the distance between the center of the x-cube combiner unit 112 and the optical center of the PBS 116a-116c. The distance “d” is identical for all three color channels. In most embodiments, there is no significant gap between the PBSs 116a-116c and the color combiner unit 112, and so the distance “d” is set by the dimensions of the optical components themselves and is not a variable. The angle “γ” is the angle between the direction of beam 118b before and after reflection at the third folding mirror 128. Thus, if the beam 118b is incident at the third folding mirror at 30°, then the value of “γ” is 60°.

From a consideration of the geometry shown in FIG. 2, and under the assumption that the optical path lengths are the same, it can be shown that:

a+(b−d)/(sin γ)=b+c (1)

and

a−(b−d)/(tan γ)=c−d (2)

From (1) and (2) it can be shown that:

b=d×(1+cos(γ)+sin(γ))/(1+cos(γ)−sin(γ)) (3)

and

c=a−b+(b−d)/sin(γ) (4)

Thus, the designer may select a desired value of “γ” and then calculate “b” using (3). The value of “a” can be selected within a range of distances in which the beam 118b is not vignetted by the lens units 132 and 134a. For the smallest system footprint, the value of “a” is selected as the smallest value within the non-vignetting range, from which the value of “c” can then be calculated.

In addition, aperture stops 140 and 142 may be positioned on the first and second separated beams 118a and 118b. The actual position of the aperture stops is dependent on the optical design of the image relay system. Furthermore, in some embodiments, a pre-polarizer 144 may be used to pre-polarize the light incident at the PBSs 116a-116c. In the illustrated embodiment, a pre-polarizer 144 is positioned closely following the exit of the integrator 106, where the light beam 104 has a small cross-section and thus the pre-polarizer 144 can also be small. Thus, the costs of the pre-polarizer may also be reduced. It will be appreciated, however, that the pre-polarizer may be positioned elsewhere. The pre-polarizer may be any suitable type of polarizer, for example a wire grid polarizer, a multilayer film polarizer or a PBS.

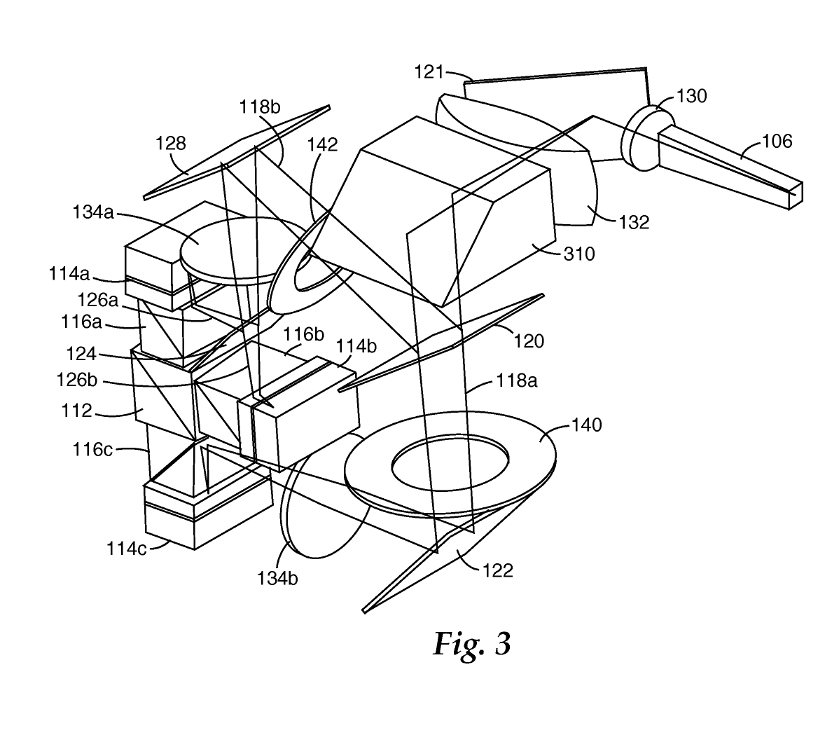

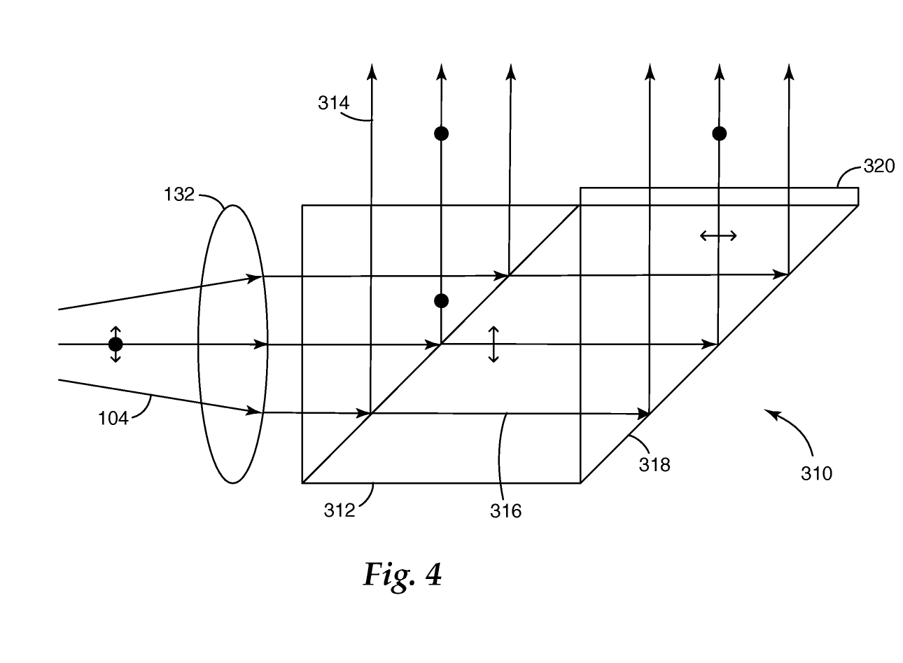

In some embodiments of projector system, the illumination light 104 may be unpolarized, but the PBSs 116a-116c direct light in only one polarization state to the imager devices 114a-114c, and so 50% of the light 104 would otherwise be unused. In the projection system 200 schematically illustrated in FIG. 3, a polarization converter unit 310 is used to convert light from the unused polarization state to the useful polarization state. The polarization converter 310 may replace the pre-polarizer 144. An embodiment of the polarization converter unit 310 is schematically illustrated in FIG. 4. Light 104 enters the polarization converter unit 310 from the second lens unit 132. The light 104 passes through a polarization beamsplitter 312, which reflects s-polarized light 314, and transmits p-polarized light 316. The p-polarized light 316 is reflected by a prism 318 to propagate substantially parallel to the s-polarized light 314 and then passes through a polarization rotator 320, for example a half-wave retardation plate, to become s-polarized.

There are two important points related to the relative orientation of the integrator and the polarization converter unit:
1. The relative orientation of the polarization converter unit 310, first folding mirror 121 and the integrator 106 can affect the uniformity of the illumination light reaching the imager devices 114a-114c. In many embodiments, the exit end of the integrator 106 is rectangular, and it is desirable that the orientation of the imager devices match the image of the exit end of the integrator 106, after all reflections are taken into account.
2. If the light integrator 106 is trapezoidal in shape, then the axial symmetrical angular distribution of light after the light source 102, and entering into integrator 106, is converted into an elliptical angular distribution after the integrator 106. It is, therefore, advantageous to orient the long side of integrator exit window along the short side of polarization converter unit 210 to provide high collection efficiency.

### The arrangement of polarization converter unit 210, folding mirror 121 and integrator 106 shown in FIG. 3 conforms with both of these points.

An advantage of the arrangement illustrated in FIG. 1 is that each illumination beam can be directed towards its respective imager device 114a-114c substantially independently of the other illumination beams. For example, folding mirror 122 may be directed to align the light beam 118a to the imager device 114c. Also, folding mirror 128 may be directed to align the beam 126b to the imager device 114b, while the dichroic separator 124 may be oriented to direct the light beam 126a to the imager device 114a. While rotation of the folding mirror 122 affects the direction of both separated beams 128a and 128b, the direction of separated beam 128a can be independently adjusted using the second dichroic separator 124.

### EXAMPLES

Two exemplary optical systems are presented. In the first optical system, there is no pre-polarizer or polarization converter, and the second lens unit is a single, plastic aspheric lens. In the second optical system, the second lens unit comprises two spherical lenses. The co-ordinates are relative to the y-z axis shown in FIG. 1, with the origin at the center of the x-cube color combiner 122. The x-axis is directed into the plane of the figure. The exemplary systems are arranged in a plane, and so the x-value for all elements is zero. The measurements of radius, thickness and clear aperture are given in mm. The values of y and z are also in mm.

### Example 1

| | | | | Clear | Coordinates (x = 0) | |
|---|---|---|---|---|---|---|
| Component | Radius | Thickness | Material | Aperture | y | z |
| Integrator | | 50.0 | | 5.9 × 5.9 | 103.00 | −166.00 |
| (106) | | 7.0 | | 10.5 × 5.9 | 103.00 | −116.00 |
| First lens | −14 | 4.0 | SK5 | 15.0 | 103.00 | −108.00 |
| unit (130) | −15.844 | 15.08 | | 20.0 | 103.00 | −104.00 |
| 1^{st} folding | Front surface mirror | | | 38 × 24 | 103.00 | −88.92 |
| mirror | | | | | | |
| (121) | | | | | | |
| 2^{nd} lens | 194.97 | 12.0 | PMMA | 44.0 | 84.00 | −88.92 |
| unit (132) | −28.331 | 25.72 | | 44.0 | 72.0 | −88.92 |
| 1^{st} dichroic | — | 1.0 | BK7 | 50 × 34 | 46.28 | −88.92 |
| (120) | | 76.25 | | 50 × 34 | 45.57 | −89.63 |
| 3^{rd} folding | Front surface mirror | | | 40 × 36 | 83.93 | −23.73 |
| mirror | | | | | | |
| (128) | | | | | | |
| 3^{rd} lens | 55.04 | 9.0 | BK7 | 44.0 | 58.68 | −23.73 |
| unit (134 a) | −92.79 | 25.61 | | 44.0 | 49.68 | −23.73 |
| 2^{nd} | — | 1.0 | BK7 | 30 × 28 | 24.07 | −23.73 |
| Dichroic | | 14.44 | | 30 × 28 | 23.36 | −24.44 |
| (124) | | | | | | |
| 1^{st} PBS | | — | | 17.5 × 30.0 | 24.07 | −8.75 |
| (116 a) | | | | | | |
| 2^{nd} PBS | | — | | 17.5 × 30.0 | 8.75 | −24.07 |
| (116 b) | | | | | | |
| 2^{nd} folding | Front surface mirror | | | 55 × 30 | −24.07 | −89.11 |
| mirror | | | | | | |
| (122) | | | | | | |
| 3^{rd} lens | 55.04 | 9.0 | BK7 | 44.0 | −24.07 | −58.68 |
| unit (134 b) | −92.79 | 40.93 | | 44.0 | −24.07 | −49.68 |
| 3^{rd} PBS | | — | | 17.5 × 30.0 | −24.07 | −8.75 |
| (116 c) | | | | | | |

The conic constant of the aspheric lens used in the second lens unit 132 is −0.6646. The angle of incidence of axial light on the first and second folding mirrors 121 and 122, and on the second dichroic separator 124, is 45°. The angle of incidence on the first dichroic separator and the third folding mirror 128 is 30°. In Example 1, the pre-polarizer and field stops are omitted.

### Example 2

| | | | | Clear | Coordinates (x = 0) | |
|---|---|---|---|---|---|---|
| Component | Radius | Thickness | Material | Aperture | y | z |
| Integrator | | 50.0 | | 5.9 × 5.9 | 123.27 | −197.78 |
| (106) | | | | 10.5 × 5.9 | 123.27 | −147.78 |
| First lens | −12.032 | 4.0 | SK5 | 15.0 | 123.27 | −138.78 |
| unit (130) | −12.993 | | | 19.0 | 123.27 | −134.78 |
| Pre- | | 1.0 | | 25.0 × 25.0 | 123.27 | −133.00 |
| polarizer | | | | | 123.27 | −132.00 |
| (144) | | | | | | |
| 1^{st} folding | Front surface mirror | | | 50.0 × 40.0 | 123.27 | −103.30 |
| mirror (121) | | | | | | |
| 2^{nd} lens unit | −680.28 | 7.5 | BK7 | 56.0 | 93.77 | −103.30 |
| (132 a) | −64.342 | | | 56.0 | 86.27 | −103.30 |
| 2^{nd} lens unit | 111.522 | 7.0 | PMMA | 56.0 | 86.17 | −103.30 |
| (132 b) | −181.441 | | | 56.0 | 79.17 | −103.30 |
| 1^{st} dichroic | | 1.0 | BK7 | 51.0 × 46.0 | 45.11 | −103.30 |
| (120) | | | | | 44.27 | −103.82 |
| Stop 142 | | | | 35.5 | 65.00 | −62.55 |
| 3^{rd} folding | Front surface mirror | | | 44.0 × 40.0 | 83.93 | −23.73 |
| mirror (128) | | | | | | |
| 3^{rd} lens unit | 58.325 | 6.5 | SK5 | 40.0 | 55.40 | −23.74 |
| (134 a) | −241.6 | | | 40.0 | 48.90 | −23.74 |
| 2^{nd} dichroic | | 1.0 | SK5 | 32.0 × 34.0 | 24.07 | −23.74 |
| (124) | | | | | 23.36 | −24.45 |
| Trim filter | | 1.0 | BK7 | 25.0 × 20.0 | 13.48 | −23.87 |
| (138) | | | | | 12.50 | −24.07 |
| 2^{nd} PBS | | — | SK5 | 17.5 × 30.0 | 8.75 | −24.07 |
| (116 b) | | | | | | |
| 1^{st} PBS | | — | SK5 | 17.5 × 30.0 | 24.07 | −8.75 |
| (116 a) | | | | | | |
| Stop (140) | | | | 35.5 | 3.00 | −103.51 |
| 2^{nd} Folding | Front Surface Mirror | | | 55.0 × 40.0 | −24.07 | −103.51 |
| mirror (122) | | | | | | |
| 3^{rd} lens unit | 58.325 | 6.5 | SK5 | 40.0 | −24.07 | −55.75 |
| (134 b) | −241.6 | | | 40.0 | −24.07 | −49.25 |
| Trim filter | | 1.0 | BK7 | 25.0 × 20.0 | −23.87 | −13.48 |
| (136) | | | | | −24.07 | −12.50 |
| 3^{rd} PBS | | | SK5 | 17.5 × 30.0 | −24.07 | −8.75 |
| 116 c | | | | | | |

The co-ordinates for mirrors show the geometrical center of the mirror surface. Each mirrors is offset −6.5 mm down in the plane of mirror. The trim filters are set so that the light is incident at an angle of 12°. The co-ordinates for the first dichroic separator 120 are for the geometrical center of the surface. The first dichroic separator 120 is offset +2.0 mm up in the plane of the reflecting layer. The co-ordinates for the second dichroic separator 124 are for the geometrical center of the surface. The second dichroic separator 124 is offset +3.0 mm up in the plane of the reflecting layer. The angle of incidence on the first dichroic separator and the third folding mirror 128 is 32°.

In the above description, the term angle of incidence, when used to describe the incidence of light having an angular distribution on a surface, refers to the angle that the axial ray makes relative to the normal to the surface.

The present disclosure should not be considered limited to the particular examples described above, but rather should be understood to cover all aspects as fairly set out in the attached claims. Various modifications, equivalent processes, as well as numerous structures to which the present disclosure may be applicable will be readily apparent to those of skill in the art to which the present disclosure is directed upon review of the present specification. The claims are intended to cover such modifications and devices.

What is claimed is:

1. An optical display system, comprising:
a light source unit capable of generating a light beam containing light in at least first, second and third color bands;
a projection core comprising a crossed color combiner having first, second and third inputs and an output, first, second and third display panels disposed to direct first, second and third image light to the first, second and third inputs respectively, the first, second and third display panels arranged for forming images in the light in the first, second and third color bands respectively;
an optical relay system for relaying light of the light beam to the first, second and third imager panels; and
a first dichroic separator disposed in the light beam between the light source and the projection core, the first dichroic separator separating light in the first color band from light in the second and third color bands, the light beam being incident on the first dichroic separator with an incident angle of incidence less than 40°, the light beam being non-telecentric where the light beam is incident on the first dichroic separator.

2. A system as recited in claim 1, wherein the incident angle is less than 35°.

3. A system as recited in claim 1, wherein the light in the second and third color bands defines a first light beam after separation from the light in the first color band, and further comprising a second dichroic separator disposed in the first light beam to separate light in the second color band from light in the third color band.

4. A system as recited in claim 1, wherein the light source unit comprises a light source and an integrating tunnel, the light source producing light of the first, second and third color bands, the optical relay system relaying an image of an output from the integrating tunnel to the first, second and third imager panels.

5. A system as recited in claim 4, wherein the light source comprises at least one of a lamp and a light emitting diode.

6. A system as recited in claim 1, wherein the display panels comprise liquid crystal imager panels.

7. A system as recited in claim 1, wherein the optical relay system comprises a first lens unit and a second lens unit common to all color bands, a first third lens unit (TLU) common to the second and third color bands, and a second (TLU) associated with the first color band, the first and second TLUs each having the same optical power.

8. A system as recited in claim 1, further comprising a second dichroic separator for separating the light in the third color band from light in the second color band, the second dichroic separator being disposed between the first dichroic separator and the projection core on an optical path of the light of the third color band, the second dichroic separator being located at a position within the image relay system where the light of the second and third color band is telecentric.

9. A system as recited in claim 1, wherein the first optical path length from the first dichroic separator to the first display panel, a second optical path length from the first dichroic separator to the second display panel and a third optical path length from the first dichroic separator to the third display panel are all substantially equal.

10. A system as recited in claim 1, further comprising a polarization converter unit to convert polarization of the light beam into a single polarization state.

11. An optical display system, comprising:
a light source unit capable of generating a light beam containing light in at least first, second and third color bands;
a projection core comprising a crossed color combiner having first, second and third inputs and an output, first, second and third display panels disposed to direct first, second and third image light to the first, second and third inputs respectively, the first, second and third display panels arranged for forming images in the light in the first, second and third color bands respectively;
an optical relay system for relaying light of the light beam to the first, second and third imager panels; and
a first dichroic separator disposed in the light beam between the light source and the projection core, the first dichroic separator separating light in the first color band from light in the second and third color bands, a first optical path length from the first dichroic separator to the first display panel for light of the first color band being substantially equal to a second optical path length from the first dichroic separator to the second display panel for light of the second color band and being substantially equal to a third optical path length from the first dichroic separator to the third display panel for light of the third color band.

12. A system as recited in claim 11, wherein the light in the second and third color bands defines a first light beam after separation from the light in the first color band, and further comprising a second dichroic separator disposed in the first light beam to separate light in the second color band from light in the third color band.

13. A system as recited in claim 11, wherein the light beam incident at the first dichroic separator is non-telecentric.

14. A system as recited in claim 11, wherein the light beam is incident on the first dichroic separator at an angle less than 40°.

15. A system as recited in claim 14, wherein the light beam is incident on the first dichroic separator at an angle less than 35°.

16. A system as recited in claim 11, wherein the light source unit comprises a light source and an integrating tunnel, the light source producing light of the first, second and third color bands, the optical relay system relaying an image of an output from the integrating tunnel to the first, second and third imager panels.

17. A system as recited in claim 16, wherein the light source comprises at least one of a lamp and a light emitting diode.

18. A system as recited in claim 11, wherein the display panels comprise liquid crystal imager panels.

19. A system as recited in claim 11, wherein the optical relay system comprises a first lens unit and a second lens unit common to all color bands, a first third lens unit (TLU) common to the second and third color bands, and a second (TLU) associated with the first color band, the first and second TLUs each having the same focal length.

20. A system as recited in claim 11, further comprising a second dichroic separator for separating the light in the third color band from light in the second color band, the second dichroic separator being disposed between the first dichroic separator and the projection core on an optical path of the light of the third color band, the second dichroic separator being located at a position within the image relay system where the light of the second and third color band is telecentric.

21. A system as recited in claim 11, further comprising a polarization converter unit to convert polarization of the light beam into a single polarization state.
